(19) United States
(12) Patent Application Publication
(10) Pub. No.: US 2025/0341606 A1
(43) Pub. Date: Nov. 6, 2025

(54) SENSOR SYSTEM

(71) Applicant: SICK AG, Waldkirch (DE)

(72) Inventors: Marius SCHWEIZER, Elzach (DE); Philipp KLEIN, Gutach (DE); Jörg KIBBEL, Waldkirch (DE)

(21) Appl. No.: 19/098,203

(22) Filed: Apr. 2, 2025

(30) Foreign Application Priority Data
May 3, 2024 (DE) 102024112481.4

(51) Int. Cl. G01S 7/00; G01S 7/51; G01S 17/08

(52) U.S. Cl. CPC G01S 7/003; G01S 7/51; G01S 17/08

(57) ABSTRACT

A sensor system comprises a sensor that outputs sensor data during operation; a web-based user interface for displaying the output sensor data on an end device and for transmitting control instructions of a user from the end device to the sensor; and a data recorder that is connected to the sensor and that is configured to receive sensor data output by the sensor and to store said sensor data on a storage medium. The data recorder has a switching device that is configured to forward sensor data received from the sensor to the web-based user interface and/or to forward control instructions received from the web-based user interface to the sensor.

The invention relates to a sensor system comprising at least one sensor that outputs sensor data during operation; a web-based user interface for displaying the output sensor data on an end device and for transmitting control instructions of a user from the end device to the sensor; and a data recorder that is connected to the sensor and that is configured to receive sensor data output by the sensor and to store said sensor data on a storage medium.

Such sensor systems are, for example, used to monitor industrial processes and to archive the process data for documentation and for a later analysis. In particular in the case of scanning sensors such as LIDAR sensors, relatively large amounts of data are in this respect generated to which the memory capacity of the data recorder must be adapted. The data recorder can also be configured to simultaneously receive and store data streams from a plurality of sensors.

Via the web-based user interface, a user can access the sensor quickly and easily in order, for example, to read out the sensor and/or to define parameters. A desktop computer, a notebook, a tablet computer or a smartphone can serve as the end device, wherein the connection to the sensor is established via a network address, for example. The user can access the web-based user interface via a browser. Accordingly, no specific software needs to be installed on the end device to communicate with the sensor.

The functions of the data recorder can be controlled via a permanently installed operating unit or via a stand-alone user interface. However, the separate communication with the sensor, on the one hand, and with the data recorder, on the other hand, involves considerable operating and maintenance effort.

Furthermore, it is inconvenient for a user to go to the data recorder in order to call up recording and playback functions.

It is an object of the invention to enable an easier operation of sensor systems of the aforementioned kind.

The object is satisfied by a sensor system having the features of claim 1.

According to the invention, the data recorder has a switching device that is configured to forward sensor data received from the sensor to the web-based user interface and/or to forward control instructions received from the web-based user interface to the sensor.

The switching device enables the sensor to be addressed via the data recorder. It is thus not necessary to provide and maintain two separate user interfaces-one for the sensor and one for the data recorder. Instead, the user can access both the sensor and the data recorder via one and the same user interface. A further development or software update can be limited to a single type of user interface.

Depending on the application, the forwarding of the sensor data and the control instructions can take place directly or via at least one additional intermediate station.

The switching device can form a proxy that is connected between the end device and the sensor. Thus, the user can communicate with the sensor as if there were a direct connection. If required, the proxy can provide additional protection functions or control functions.

According to one embodiment of the invention, the data recorder is configured to retrieve stored sensor data from the storage medium, wherein the switching device is configured to forward the retrieved sensor data to the web-based user interface. Thus, the user can not only have current sensor data displayed via the web-based user interface, but also archived sensor data. The type of display is preferably identical for current sensor data and for stored sensor data.

The data recorder is preferably controllable via the web-based user interface. The operation of the sensor system is thereby further simplified. A start and stop of storage processes, a retrieval of stored data sets and/or a setting of parameters of the data recorder via the web-based user interface can in particular be provided. For this purpose, the data recorder, in particular the switching device, can provide a programming interface (application programming interface, API) via which the recording, storage and playback of sensor data are controlled.

The data recorder can be configured to display at least one control panel on the end device, said control panel relating to the control of the data recorder, by means of the web-based user interface. Thus, the data recorder can be controlled in a particularly simple manner—depending on the end device, via a touchscreen or other input devices such as a keyboard or a mouse.

According to a specific embodiment of the invention, the at least one control panel is superposed on a display field provided for displaying the sensor data. Thus, the user can control the data recorder by means of the control panel without having to interrupt the display of the sensor data for this purpose.

The at least one control panel can have at least one operating element for starting a storage process and/or at least one operating element for starting a retrieval process. Thus, the basic functions of the data recorder can be called up via the web-based user interface. The stopping of a started storage process can likewise take place via the operating element for starting a storage process, wherein the display of the operating element preferably changes from “Start” to “Stop” when the storage process is running. The operating element for starting a retrieval process can have a second level that is called up when it is selected and that enables a selection of stored data sets.

According to a further embodiment of the invention, the switching device is configured, at least in a live mode, to forward all the sensor data received from the sensor to the web-based user interface and to forward all the control instructions received from the web-based user interface to the sensor. Thus, the user views all the current sensor data as if the user were directly connected to the sensor.

The data recorder can comprise a network-compatible computer and at least one data storage device connected thereto. This enables the provision of a particularly large storage capacity and supports a central archiving of different process data. The data storage device can comprise a hard disk drive, a solid-state drive and/or a network storage device. The computer can be operated as a server and can provide a specific file system or a database for the sensor data.

A further embodiment of the invention provides that the sensor system comprises a plurality of sensors and the switching device is formed by a server that is connected to each of the sensors and that is configured to forward sensor data of all the connected sensors to the web-based user interface and to forward control instructions that are received from the web-based user interface and that are intended for one of the connected sensors to the respective sensor. Thus a multitude of different sensor data can be managed centrally.

The sensor is preferably a laser scanner, in particular a LIDAR sensor. The sensor can generally also be a RADAR sensor or a TOF sensor (“time-of-flight” sensor). The advantages of the invention are particularly evident with sensors that generally output a particularly large amount of data.

The invention also relates to a method of controlling a sensor system that comprises at least one sensor, which outputs sensor data during operation, and a data recorder for storing the sensor data output by the sensor on a storage medium, in particular a method of controlling a sensor system as described above.

The method according to the invention comprises the steps:
establishing a connection between the data recorder and the sensor,
establishing a connection between the data recorder and a separate end device,
forwarding sensor data from the sensor to the end device by means of a switching device of the data recorder,
displaying the forwarded sensor data on the end device by means of a web-based user interface,
receiving control instructions of a user at the end device via the web-based user interface, and
forwarding the control instructions from the end device to the sensor by means of the switching device.

The sensor is therefore addressed via the data recorder. Thus, the web-based user interface can be used both for accessing the sensor and for accessing the data recorder. It is then not necessary to provide and maintain two separate user interfaces.

Provision can be made that sensor data output by the sensor are stored on the storage medium and/or previously stored sensor data are retrieved from the storage medium if this is instructed by a user via the web-based user interface. Thus, at least the basic functions of the data recorder can be called up in a web-based manner via the user interface of the sensor.

Sensor data retrieved from the storage medium are preferably displayed on the end device by means of the web-based user interface if this is instructed by a user via the web-based user interface. Therefore, the user can not only have current sensor data displayed on the end device, but also previously saved sensor data.

Further developments of the invention can also be seen from the dependent claims, from the description and from the enclosed drawings.

The invention will be described in the following by way of example with reference to the drawings.

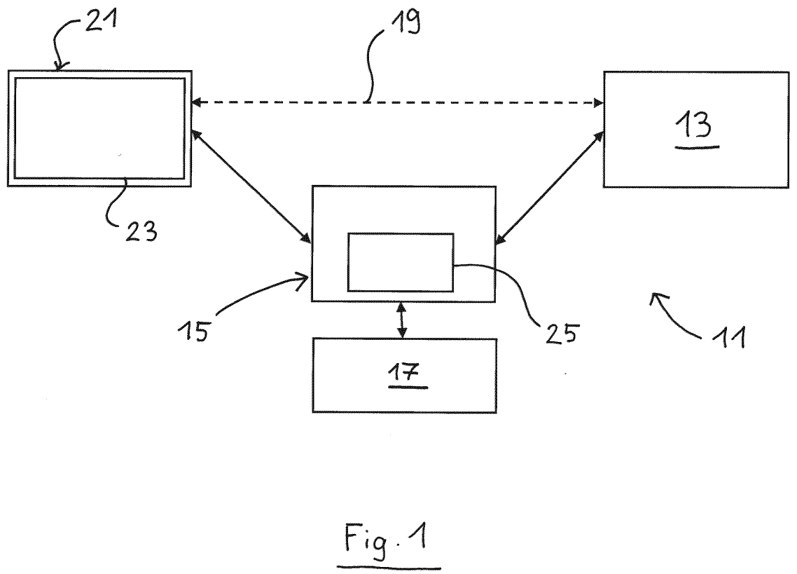

FIG. 1 is a schematic representation of a sensor system according to the invention;

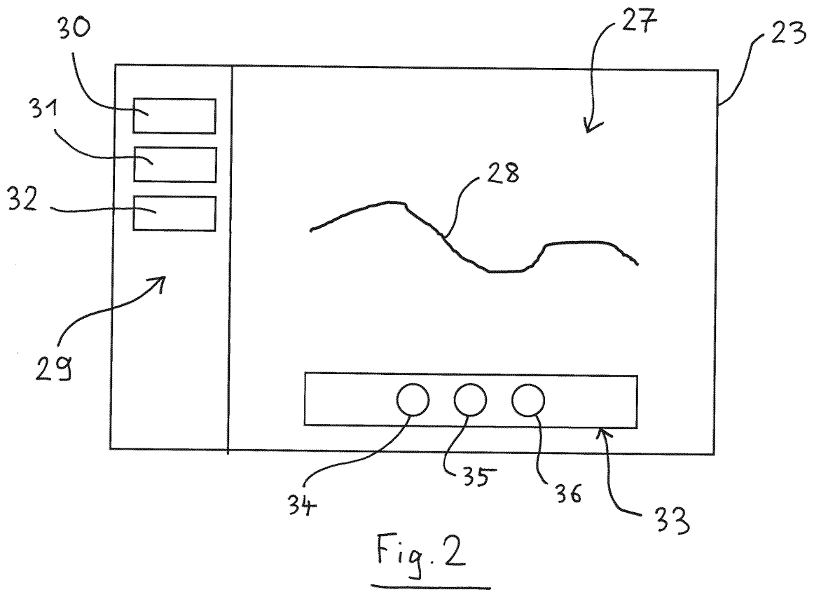

FIG. 2 shows a web-based user interface of the sensor system according to FIG. 1.

The sensor system 11 that is shown in FIG. 1 and that is designed according to one embodiment of the invention comprises a sensor 13 such as a LIDAR sensor. The sensor 13 is configured to detect at least one measurement variable and to output a continuous stream of sensor data, such as distance data.

Furthermore, the sensor system 11 comprises a data recorder 15 which is connected to the sensor 13 and with which a storage medium 17 is associated. The data recorder 15 is configured to receive the sensor data output by the sensor 13 and to store said sensor data at least partly on the storage medium 17. The data recorder 15 can comprise a network-compatible computer that has access to a file system, a database or a network memory. The data recorder 15 can also be designed as a central server that is simultaneously connected to a plurality of sensors 13, which is not shown in FIG. 1, however.

The sensor 13 is network-compatible and is connected to an end device 21, such as a tablet computer, via a direct connection 19. A user can address the sensor 13 via a web-based user interface 23 that is implemented on the end device 21. The web-based user interface 23 in particular serves to display the sensor data currently output by the sensor 13—in graphical form and/or as character strings, depending on the application—and to transmit control instructions such as parameter changes to the sensor 13.

The data recorder 15 has a switching device 25 that forms a proxy that is connected between the end device 21 and the sensor 13. During the operation of the sensor system 11, the switching device 25 is configured to forward all the sensor data received from the sensor 13 to the web-based user interface 23 and to forward all the control instructions received from the web-based user interface 23 to the sensor 13. Thus, the sensor 13 can be addressed and controlled indirectly, namely via the data recorder 15, so that the direct connection 19 is not absolutely necessary and could also be omitted in certain application situations.

Furthermore, the data recorder 15 is controllable via the web-based user interface 23. For this purpose, an application runs on the data recorder 15 and provides a programming interface for data storage and data playback. The user can then control the functions of the data recorder 15 via the end device 21 and can moreover have stored sensor data displayed, as will be explained in more detail below with additional reference to FIG. 2.

FIG. 2 shows an exemplary design of the web-based user interface 23. The web-based user interface 23 can be called up via any desired conventional browser application and comprises a display field 27 for displaying sensor data, shown here by way of example as a curve 28. Furthermore, a sensor control field 29 comprising a plurality of control elements 30, 31, 32 serves to make parameter settings at the sensor 13 (FIG. 1) as required. A data recorder control panel 33 comprising a plurality of operating elements 34, 35, 36 is superposed on the display field 27.

When a user calls up the network address of the sensor 13 via the browser application, the web-based user interface 23 only contains the display field 27 and the control field 29, but not the data recorder control panel 33. The user can then communicate with the sensor 13 without involving the data recorder 15, i.e. can view the current sensor data and can carry out a parameterization if required.

If, on the other hand, the user calls up the network address of the data recorder 15, the web-based user interface 23 contains not only the display field 27 and the control field 29, but also the data recorder control panel 33 as shown in FIG. 2. The user can communicate with the sensor 13 in the same way as during a direct call-up of said sensor 13 and can in particular view the current sensor data on the display field 27. All data traffic runs via the data recorder 15 in this respect.

Furthermore, the user can access the data recorder 15 in a controlling manner by means of the operating elements 34, 35, 36 of the data recorder control field 33. For example, the user can start or stop a storage process. Similarly, stored sensor data can be retrieved from the storage medium 17 by means of the data recorder control field 33 and can be displayed on the display field 27 instead of the current sensor data. The switching device 25 of the data recorder 15 in this respect ensures that the sensor data retrieved from the storage medium 17 are forwarded to the web-based user interface 23.

The web-based user interface 23 can have a switch panel, not shown in FIG. 2, by means of which a switch can be made between a live mode, in which all the sensor data output by the sensor 13 are displayed in real time on the display field 27, and a playback mode in which stored and previously selected sensor data are displayed on the display field 27.

To control the sensor system 11, a connection is established between the data recorder 15 and the sensor 13 and between the end device 21 and the data recorder 15 via a network, for example via a local network or via the Internet. All the sensor data are transmitted from the sensor 13 to the web-based user interface 23 of the end device 21 by means of the switching device 25 and are displayed on the display field 27. If control instructions for the sensor 13 are output via the control elements 30, 31, 32 of the web-based user interface 23, said control instructions are forwarded from the switching device 25 to the sensor 13. If the user outputs a control instruction relating to the data recorder 15, for example to start a storage process, via the data recorder control field 33, said control instruction is executed on the data recorder 15. When stored sensor data are retrieved from the data recorder 15, the stored sensor data are displayed on the display field 27 instead of the live sensor data.

Since the sensor 13, on the one hand, and the data recorder 15, on the other hand, are addressed via the same web-based user interface 23, no separate user interfaces need to be provided and maintained. The control of both devices can take place conveniently by means of a handy end device 21 via a wired or wireless network.

### REFERENCE NUMERAL LIST

11 sensor system
13 sensor
15 data recorder
17 storage medium
19 direct connection
21 end device
23 web-based user interface
25 switching device
27 display field
29 sensor control field
30 control element
31 control element
32 control element
33 data recorder control field
34 control panel
35 control panel
36 control panel

1. A sensor system comprising
at least one sensor that outputs sensor data during operation;
a web-based user interface for displaying the output sensor data on an end device and for transmitting control instructions of a user from the end device to the sensor; and
a data recorder that is connected to the sensor and that is configured to receive sensor data output by the sensor and to store said sensor data on a storage medium,
wherein the data recorder has a switching device that is configured to forward sensor data received from the sensor to the web-based user interface and/or to forward control instructions received from the web-based user interface to the sensor.

2. The sensor system according to claim 1,
wherein the switching device forms a proxy that is connected between the end device and the sensor.

3. The sensor system according to claim 2,
wherein the data recorder is configured to retrieve stored sensor data from the storage medium and wherein the switching device is configured to forward the retrieved sensor data to the web-based user interface.

4. The sensor system according to claim 1,
wherein the data recorder can be controlled via the web-based user interface.

5. The sensor system according to claim 4,
wherein the data recorder is configured to display at least one control panel, which relates to the control of the data recorder, on the end device by means of the web-based user interface (23).

6. The sensor system according to claim 5,
wherein the at least one control panel is superposed on a display field provided for displaying the sensor data.

7. The sensor system according to claim 5,
wherein the at least one control panel has at least one operating element for starting a storage process and/or at least one operating element for starting a retrieval process.

8. The sensor system according to claim 1,
wherein the switching device is configured, at least in a live mode, to forward all the sensor data received from the sensor to the web-based user interface and to forward all the control instructions received from the web-based user interface to the sensor.

9. The sensor system according to claim 1,
wherein the data recorder comprises a network-compatible computer and at least one data storage device connected thereto.

10. The sensor system according to claim 1,
wherein the sensor system comprises a plurality of sensors and the switching device is formed by a server that is connected to each of the sensors and that is configured to forward sensor data of all the connected sensors to the web-based user interface and to forward control instructions that are received from the web-based user interface and that intended for one of the connected sensors to the respective sensor.

11. The sensor system according to claim 1,
wherein the sensor is a laser scanner.

12. The sensor system according to claim 11,
wherein the laser scanner is a LIDAR sensor.

13. A method of controlling a sensor system that comprises at least one sensor, which outputs sensor data during operation, and a data recorder for storing the sensor data output by the sensor on a storage medium, said method comprising the steps:
establishing a connection between the data recorder and the sensor,
establishing a connection between the data recorder and a separate end device,
forwarding sensor data from the sensor to the end device by means of a switching device of the data recorder,
displaying the forwarded sensor data on the end device by means of a web-based user interface,
receiving control instructions of a user at the end device via the web-based user interface, and
forwarding the control instructions from the end device to the sensor by means of the switching device.

14. The method according to claim 13, wherein the sensor system sensor system comprises the at least one sensor that outputs sensor data during operation;
the web-based user interface for displaying the output sensor data on an end device and for transmitting control instructions of a user from the end device to the sensor; and
the data recorder that is connected to the sensor and that is configured to receive sensor data output by the sensor and to store said sensor data on a storage medium,
wherein the data recorder has the switching device that is configured to forward sensor data received from the sensor to the web-based user interface and/or to forward control instructions received from the web-based user interface to the sensor.

15. The method according to claim 13,
wherein sensor data output by the sensor are stored on the storage medium and/or previously stored sensor data are retrieved from the storage medium if this is instructed by a user via the web-based user interface.

16. The method according to claim 13,
wherein sensor data retrieved from the storage medium are displayed on the end device by means of the web-based user interface if this is instructed by a user via the web-based user interface.
